(19) United States
(12) Patent Application Publication
(10) Pub. No.: US 2007/0009405 A1
(43) Pub. Date: Jan. 11, 2007

(54) Method and apparatus for producing gas atom containing fullerene, and gas atom containing fullerene

(75) Inventors: Rikizo Hatakeyama, Sendai-shi, Miyagi (JP); Takamichi Hirata, MIyagi (JP); Yasuhiko Kasama, Miyagi (JP); Kenji Omote, Miyagi (JP)

Correspondence Address: YOUNG & THOMPSON, 745 SOUTH 23RD STREET, 2ND FLOOR, ARLINGTON, VA, 22202, US

(73) Assignee: Ideal Star Inc., Miyagi (JP)

(21) Appl. No.: 10/552,709

(22) PCT Filed: Apr. 7, 2004
(86) PCT No.: PCT/JP04/05012

§ 371 Date: Jul. 26, 2006

(30) Foreign Application Priority Data
Apr. 7, 2003 (JP) 2003-103506

(51) Int. Cl. C01B 31/02; B01J 19/12

(52) U.S. Cl. 422/186.04; 423/445 B; 977/847; 422/186.21

(57) ABSTRACT

A method and apparatus for enabling the production of gas containing fullerenes at a high yield. The apparatus includes a plasma generating chamber with a gas inlet where a gas containing atom to be doped is introduced via the gas inlet into the plasma generating chamber to be converted into a plasma there, and an evacuated vessel which is so constructed as to communicate with the plasma generating chamber to produce a plasma flow and to introduce fullerenes into the plasma flow. The apparatus further includes control elements for controlling the energy of electrons in plasma in the evacuated vessel towards the plasma generating chamber, and a potential body for controlling the velocity of ions derived from the gas atom so as to bind the ions to fullerene ions to cause thereby endohedral fullerens to be formed.

### TECHNICAL FIELD

The present invention relates to an apparatus and method for producing gas atom containing fullerenes, and to gas atom containing fullerenes. The term “gas atom” used herein refers not only to hydrogen, nitrogen, fluorine, etc., that are a gas at normal temperature but also to sodium, potassium, etc., that are a solid or liquid at normal temperature but turn into a gas at high temperatures and can be treated as such at high temperatures.

### BACKGROUND ART

(Non-Patent Document 1)

Journal of Plasma and Fusion Research 75(8):927-933 (August 1999)

A proposed technique useful for the production of endohedral fullerenes is presented in FIG. 7 of Non-Patent Document 1.

The technique consists of forming a plasma flow of an atom to be doped in an evacuated vessel, applying a jet stream of fullerenes thereto, and allowing fullerenes doped with the atom to deposit on a deposition plate placed downstream of the plasma flow to produce endohedral fullerenes.

According to this technique, it is possible to produce endohedral fullerenes at a high yield at a low temperature.

However, this technique is problematic in that the yield of endohedral fullerenes is rather low at the center of the deposition plate. Specifically, when the yield of endohedral fullerenes is considered in terms of the radius of the plasma flow which has a circular cross-section, fullerenes successfully doped with the atom concentrate on the periphery whereas endohedral fullerenes hardly deposit at or around the center of the plate.

Recently, the endohedral fullerene attracts attention because of its prospective use for a variety of applications, and the technique which will enable the higher yield production of endohedral fullerenes than is possible with conventional techniques is demanded.

In addition, the currently available technique involved in the production of endohedral fullerenes exclusively concerns with the production of metal-doped fullerenes, and no technique has been known that enables the introduction of a gas atom into fullerenes.

The present invention aims to provide an apparatus and method enabling the higher yield production of gas-atom containing fullerenes than is possible with conventional apparatuses and methods, and such gas-atom containing fullerenes.

### DISCLOSURE OF INVENTION

The apparatus for producing gas atom containing fullerenes according to the present invention is an apparatus for producing gas atom containing fullerenes comprising a plasma generating chamber with a gas inlet where a gas to be doped is introduced via the gas inlet into the plasma generating chamber to be converted into a plasma there, and an evacuated vessel which is so constructed as to communicate with the plasma generating chamber to produce a plasma flow and to introduce fullerenes into the plasma flow such that at least part of the fullerenes are ionized, said evacuated vessel being equipped, on the side opposite to the plasma generating chamber, with means for controlling the energy of electrons in plasma flow, and downstream of plasma flow with a potential body for controlling the velocity of ions derived from the gas atom so as to bind the ions to fullerene ions to cause thereby endohedral fullerens to be formed.

For producing endohedral fullerenes doped with a positively charged atom such as hydrogen atom doped fullerenes, nitrogen atom-doped fullerenes, or alkali metal atom-doped fullerenes, a gas comprising gas atoms to be doped is introduced via the gas inlet into the plasma generating chamber. Then, a plasma comprising positively charged ions derived from gas atoms to be doped and electrons is generated in the plasma generating chamber. A negative potential is applied to cause the plasma to flow. At the same time, a negative voltage is applied to the electron energy controlling means to reduce the velocity of electrons. Application of the potentials is adjusted such that, when fullerenes are introduced into the plasma, the fullerenes will incorporate electrons to be negatively charged. A positive voltage is applied to the potential body to reduce the velocity of positively charged gas ions to a level corresponding to the migration velocity of fullerenes so as to facilitate the binding of the gas ions to the fullerenes to cause thereby endohedral fullerenes to be formed.

For producing endohedral fullerenes doped with a halogen gas, a halogen compound (for example CF₄) or a halogen gas is introduced together with an inert gas via the gas inlet into the plasma generating chamber. Then, a plasma comprising positively charged ions (for example CF₃⁺) derived from the halogen compound, or from the inert gas, and negatively charged halogen ions is generated in the plasma generating chamber. A negative potential is applied to cause the plasma to flow. The electron energy controlling means is allowed to stay afloat. When fullerenes are introduced into the plasma, the electrons of fullerenes are expelled, and positively charged fullerenes are obtained. A negative voltage is applied to the potential body to reduce the velocity of negatively charged gas ions to a level corresponding to the migration velocity of fullerenes so as to facilitate the binding of the gas ions to the fullerenes to form thereby endohedral fullerenes.

The method for producing gas atom containing fullerenes according to the present invention is a method for producing gas atom containing fullerenes comprising the steps of introducing a gas comprising atoms to be doped into a plasma generating chamber, generating a plasma in the plasma generating chamber, applying a negative potential to the plasma to evoke a plasma flow, introducing fullerenes into the plasma flow to ionize the fullerenes, and binding the atoms to be doped to fullerenes to form thereby endohedral fullerenes.

For producing endohedral fullerenes doped with a positively charged gas atom such as hydrogen atom-doped fullerenes, or nitrogen atom-doped fullerenes, the velocity of electrons constituting the plasma is controlled such that the electrons bind to fullerenes injected into the plasma to form thereby negatively charged fullerene ions.

For producing endohedral fullerenes doped with a negatively charged gas atom such as halogen atom-doped fullerenes, plasma flow is accelerated so much, when fullerenes are introduced into the plasma flow, that fullerenes the electrons of fullerenes are expelled, to produce thereby positively charged fullerene ions.

The gas atom containing fullerene according to the present invention is a fullerene containing, in its interior, a gas atom ion including a hydrogen ion, a nitrogen ion, an alkali metal ion, or a halogen gas ion.

### BRIEF DESCRIPTION OF THE DRAWINGS

FIG. 1 is a diagram for showing the outline of an apparatus for producing endohedral fullerenes representing an embodiment of the present invention.

FIG. 2 illustrates an exemplary winding of wires in the making of a coil set around a plasma generating chamber.

FIG. 3 illustrates an alternative winding of wires in the making of a coil set around a plasma generating chamber.

FIG. 4 is an example of a potential body consisting of a substrate body.

FIG. 5 is another example of the potential body consisting of a mesh body.

FIG. 6 shows a vessel for storing endohedral fullerenes.

FIG. 7 is a diagram for showing the outline of a conventional apparatus for producing metal-doped fullerenes.

### EXPRESSION OF REFERENCE LETTERS

4. Plasma generating chamber
6, 6a, 6b, 16, 17. Coil
5a, 5b, 5c. Divided potential body
7a, 7b, 7c. Means for applying bias voltages
10. Evacuation pump
602. Coil
603, 608. Magnetic field generating means
604. Energy controlling means
606. Material vessel
607. Cylinder
609. Potential body (substrate body)
610. Evacuated vessel
611. Plasma generating chamber
621, 622. RF power source
630. Gas containing atoms to be doped
641. Power source
650. Gas inlet
651. Fullerene
652. Fullerene inflow aperture
660. Plasma flow
680. Potential body (mesh body)
690. Storage vessel

### BEST MODE FOR CARRYING OUT THE INVENTION

### Embodiment 1

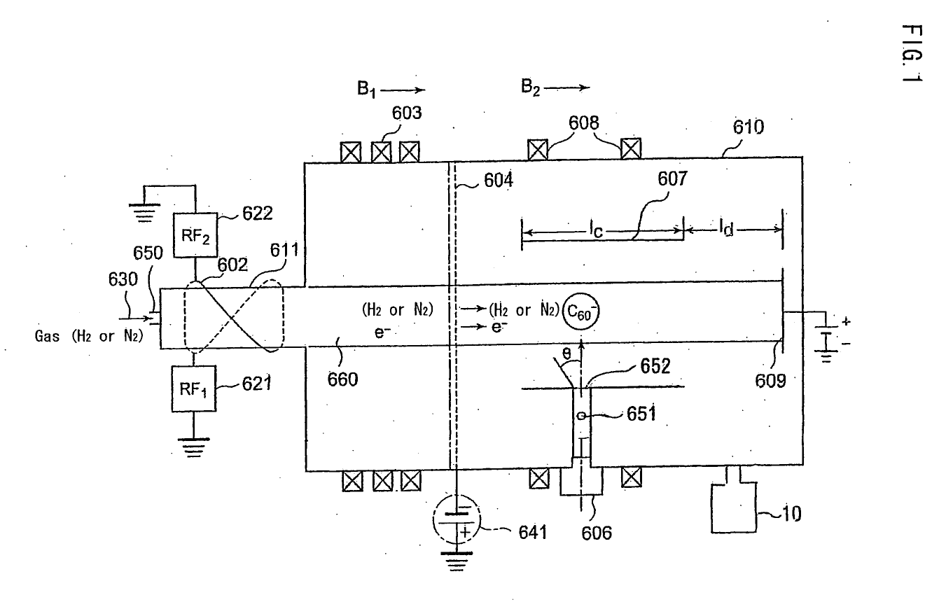

FIG. 1 shows an apparatus for producing endohedral fullerenes representing an embodiment of the present invention.

The apparatus comprises a plasma generating chamber 611 with a gas inlet 650 where a gas 630 to be doped is introduced via the gas inlet into the chamber to be converted into a plasma there, and an evacuated vessel 610 which is so constructed as to communicate with the plasma generating chamber to produce a plasma flow 660 and to introduce fullerenes 651 into the plasma flow, the evacuated vessel 610 being equipped, towards the plasma generating chamber 611, with means (energy controlling means) 604 for controlling the energy of electrons in plasma flow. When it is required to produce fullerenes doped with an alkali metal atom which usually exists as a solid or liquid at normal temperature, a gas generating unit may be added at a stage preceding the gas inlet 650 so as to produce an alkali metal gas there which is then transferred via gas inlet 650 into the plasma generating chamber.

The operation of this apparatus will be described in detail below.

In this embodiment, the plasma generating chamber 611 is made of an insulating material (e.g., quartz). A coil 602 is wound around the external surface of the plasma generating chamber. The coil 602 may be constituted of two wires, to which RF power sources 621, 622 are connected to flow RF currents therethrough.

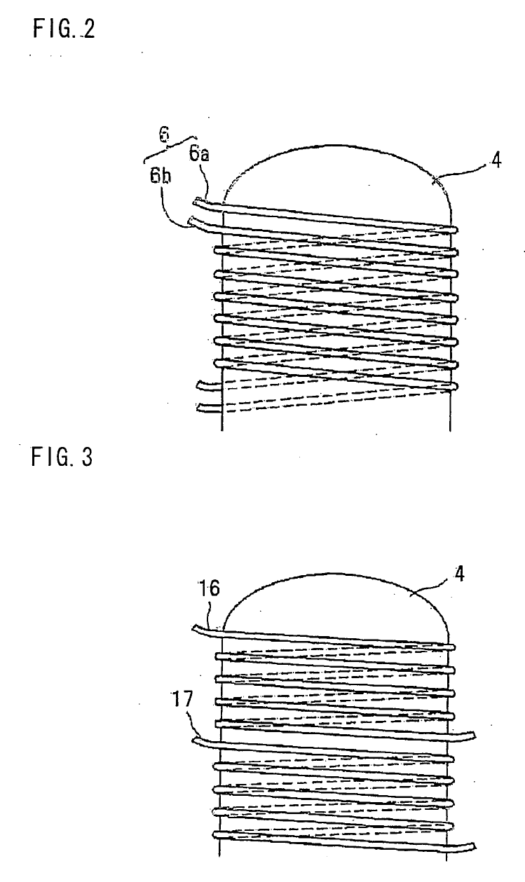

For making the coil, as shown in FIG. 2, a pair of wires 6a, 6b may be wound in a spiral pattern. Then, RF₁ and RF₂ currents different in phase are preferably flowed through the paired wires 6a, 6b, respectively.

According to the embodiment, since two RF currents different in phase, for example, by 180° are flowed through first and second coil elements 6a and 6b, a larger difference is generated between the electric fields of the coil elements 6a and 6b than would be otherwise possible. If only a single wire coil is employed, heat generated as a result of electromagnetic induction will dissipate outward, and the energy will be wasted. In this embodiment, since the inductionless winding of wires is employed in the making of a coil, it is possible to prevent the energy of electromagnetic induction from dissipating outside, and to use the energy exclusively for the generation of a plasma. In a plasma generating chamber 611 equipped with such a coil, therefore, the plasma exhibits a higher density throughout the space of the chamber, efficiency of the production of ions and radicals is enhanced, and the number of electrons bound to fullerenes in the evacuated vessel 610 is increased.

Alternatively, a pair of wires may be wound spirally in parallel as shown in FIG. 3 such that a pair of two discharge coils, i.e., first coil element 16 and second coil element 17 may be obtained. Then, two RF currents different in phase may be flowed through the first and second coil elements.

According to this embodiment, since two RF currents different in phase are flowed through the first and second coil elements 16 and 17, a larger difference is generated between the electric fields of the coil elements 16 and 17 than would be otherwise possible. In a plasma generating chamber equipped with such a coil, therefore, the plasma exhibits a higher density at the center portion of the chamber 4, and wasteful consumption of the energy of induction heating is effectively prevented.

According to the plasma generating chamber configured as above, it is possible to generate a plasma flow having a density as high as 10¹⁷/cm³ or more. It is also possible to readily generate a plasma where the temperature of electrons is 20 eV or lower, or even 10 eV or lower. It is further possible to readily generate a plasma having a high aspect ratio. Thus, a plasma flow is obtained that will enter into the evacuated vessel.

RF₁ and RF₂ power sources may work, for example, at a frequency of 1 kHz to 200 MHz, and have a power of 0.1 kW or more.

The coil elements wound around the plasma generating chamber 4 is not limited to two in number as is shown in FIGS. 2 and 3. For example, three or more coil elements may be wound and RF currents different in phase from each other may be flowed through them.

To the plasma generating chamber 611 is joined an evacuated vessel 610.

Means 603 (electromagnetic coil) is provided on the evacuated vessel 610 towards plasma generating chamber 611 to generate a magnetic field B1. The plasma thus generated is entrapped in the evacuated vessel 610 in its axial direction along a uniform magnetic field (B=2 to 7 kG) generated by electromagnetic coil 603. Thus, a high density plasma flow 660 is obtained.

A container 606 for storing fullerenes is attached to the evacuated vessel 610. The container may comprise a crucible where fullerenes are stored, and, when necessary, the crucible may be heated to sublimate the fullerenes 651 to be transferred to the vessel.

Means 604 for controlling the energy of electrons of a plasma is provided between the fullerene inlet and the plasma generating chamber 611. The energy controlling means 604 is a grid of wires woven into a mesh, to which a negative potential is applied. The grid 604 is connected to a power source 641. The potential applied to the grid may be varied. Alternatively, the potential applied to the grid may be varied automatically or manually depending on the value obtained by measuring the energy of electrons present at the downstream side of the grid 604 (rightward in the figure).

The grid 604 is activated only when it is required to dope fullerenes with a gas atom which becomes a positively charged ion by releasing an electron in plasma, such as hydrogen, nitrogen, or alkali metal. Applying a negative potential to grid 604 to reduce the velocity of electrons in a plasma flow to a level corresponding to the velocity of fullerenes introduced in the plasma flow enables the electrons to bind to the fullerenes to produce negatively charged fullerenes.

The energy of electrons downstream of the grid 604 is preferably at 10 eV or lower, more preferably at 5 eV. It is possible to obtain electrons at a desired energy level by adjusting the potential applied to the grid. Electrons in plasma set to such an appropriate energy level readily bind to fullerenes 651. Therefore, it is possible to obtain negatively charged fullerene ions at a high density. In view of the difficulty with which electrons are controlled, the lower limit of the energy level of electrons is preferably set to 0.5 eV. On the contrary, if the energy level of electrons exceeds 20 eV, the electrons will drive out the electrons of fullerenes.

When it is required to dope fullerenes with a halogen gas atom which will become a negatively charged ion in plasma by giving an electron to an atom of inert gas or others there, the grid 604 may be allowed to stay afloat. Then, the plasma flow staying at a high energy level will drive out electrons from fullerenes to produce positively charged fullerene ions.

Downstream of plasma flow 660, there is provided a substrate plate 609 serving as a potential body. To the potential body 609 is preferably applied a bias voltage which has the same polarity with that of the atom to be doped and present in plasma flow. When such a bias voltage is applied, the velocity of the doping atom relative to that of fullerenes is reduced. Reducing the relative velocities between the two kinds of ions facilitates coulomb interactions between those two ions, which will help the doping ion to be introduced into fullerenes.

Preferably in the evacuated vessel 610, there is provided a plasma measurement probe for determining the velocities of fullerene ions and the doping atom, and doping is adjusted depending on the measurements provided by the probe. Specifically, the signal from the probe is utilized for determining a voltage to be applied to the potential body 609 so that the velocity of the doping atom relative to that of fullerenes can be reduced.

The radius of plasma generating chamber 611 is nearly equal to the radius of a plasma flow 660. Thus, it is possible to alter the radius of plasma flow 660 as appropriate by adjusting the radius of plasma generating chamber 611 depending on the overall size of the apparatus. It is also possible to alter the radius of plasma flow 660 by varying the intensity of uniform magnetic fields B1, B2 generated by magnetic field generating means 603, 608.

Incidentally, around the external wall of the evacuated vessel 610 there is provided a cooling means (not illustrated). The internal wall of evacuated vessel 610 is cooled by virtue of the cooling means such that the internal wall of evacuated vessel 610 can capture neutral gas molecules. It is possible to produce a plasma free from contaminants by allowing neutral gas molecules to be adsorbed to the internal wall, and thus to allow highly pure endohedral fullerenes to be deposited on the potential body 609. In particular, if a cylinder 607 is introduced in the vessel 610, the cooling means is preferably set with respect to the evacuated vessel 610 such that at least a portion of the inner wall of evacuated vessel 610 surrounding the space between the downstream end of the cylinder 607 and the potential body 609 can be cooled. The temperature of the inner wall of evacuated vessel 610 is preferably kept at room temperature or lower, more preferably 0° C. or lower. If the temperature in question is kept within the above range, the adsorption of neutral gas molecules to the inner wall will be facilitated, and high yield acquisition of highly pure endohedral fullerenes will be ensured.

In this embodiment, a copper-made cylinder 607 is provided with respect to the evacuated vessel such that the cylinder 607 can surround the plasma flow 660 midway on its course. The cylinder 607 has an aperture on its wall so that fullerenes injected trough the aperture can be introduced into the plasma flow 660. Prior to the introduction of fullerenes, the cylinder 607 is preferably heated in advance to a temperature allowing the sublimation of fullerenes, that is, 400 to 650° C. After being introduced into the interior of cylinder 607, the portion of fullerenes that are not ionized even through being brought into contact with plasma are adsorbed to the inner wall of cylinder to be sublimated again. If the temperature of cylinder 607 is below 400° C., renewed sublimation of adsorbed fullerenes would not occur efficiently. On the contrary, if the temperature of cylinder 607 is over 650° C., renewed sublimation would produce superfluous C₆₀ which would result in the overproduction of C₆₀ not doped with a target gas atom, thus impairing the efficient utilization of C₆₀. Accordingly, the temperature of cylinder 607 is preferably kept at 400 to 650° C.

The cylinder 607 is kept more preferably at 480 □620° C. If the temperature in question is below 480° C., the density of fullerene ions will disadvantageously lower. If the temperature is over 620° C., non-ionized neutral fullerenes will become so numerous as to lower the doping efficiency significantly.

The internal diameter of cylinder 607 is preferably set to a size 2.5 to 3.0 times as large as the diameter of plasma flow 660, more preferably 2.7 to 2.8 times.

If the internal diameter in question is below 2.5 times the diameter of plasma flow 660, interaction of cylinder 607 with plasma flow 660 will be so intensified as to impair the secure retention of plasma flow 660 by cylinder 607. This will, unless properly handled, will lead to the reduced yield of endohedral fullerenes.

On the contrary, if the internal diameter exceeds 3.0 times, the time of plasma persistence will be shortened, which, unless properly handled, will lead to the reduced yield of endohedral fullerenes.

According to the apparatuses disclosed in Non-Patent Document 1, the yield varies from one apparatus to another. The present inventors found that the inner radius of cylinder greatly has a significant effect on the yield. In particular, they found that the yield varies depending on the diameter of plasma flow 660 relative to the diameter of cylinder 607. They found further that when the inner diameter of cylinder 607 is made 2.5 to 3.0 times as large as the diameter of plasma flow, the yield is markedly increased.

A fullerene inflow aperture 652 is provided on cylinder 607. When a jet of fullerenes is introduced through the aperture into the cylinder 607, upon entry the jet expands with a certain expansion angle θ. The expansion angle θ is preferably kept in the range of 90 to 120°. Provided that the expansion angle θ is kept within the above range, introduction of fullerenes 651 into plasma 660 occurs highly efficiently, and the yield of endohedral fullerenes is increased. Incidentally, to alter the expansion angle θ, it is only necessary to vary the ratio between the diameter and the length of an inlet nozzle through which fullerenes are introduced into the cylinder.

In the embodiment shown in FIG. 1, fullerenes are depicted to enter the cylinder from down upward in the figure. However, fullerenes may be introduced from a side, or from both sides simultaneously.

The cylinder 607 does not necessarily have the same diameter along its long axis. For example, the cylinder may consist of two segments different in diameter: one segment containing the fullerene inflow aperture 652 may have a diameter 3.0 times as large as that of plasma flow, and the other segment downstream of the first segment may have a diameter 2.5 times as large as the plasma flow with the junction having a taper smoothly connecting the two segments. The cylinder configured as above will restrict the expansion of plasma flow thereby contributing to the increased yield of endohedral fullerenes.

The speed at which fullerens are introduced may be adjusted by changing the temperature increment of the oven for fullerene sublimation. The temperature increment of the oven is preferably chosen to be 100° C./min or higher. The upper limit of the temperature increment is the maximum temperature increment at which bumping is safely avoidable.

In the evacuated vessel 610, there is provided, ahead of the potential body 609, an ion measurement probe for measuring the distribution of ions. The signal from the probe is transmitted to a probe circuit and a computer so that the bias voltage to be applied to the potential body 609 can be adjusted based on the signal.

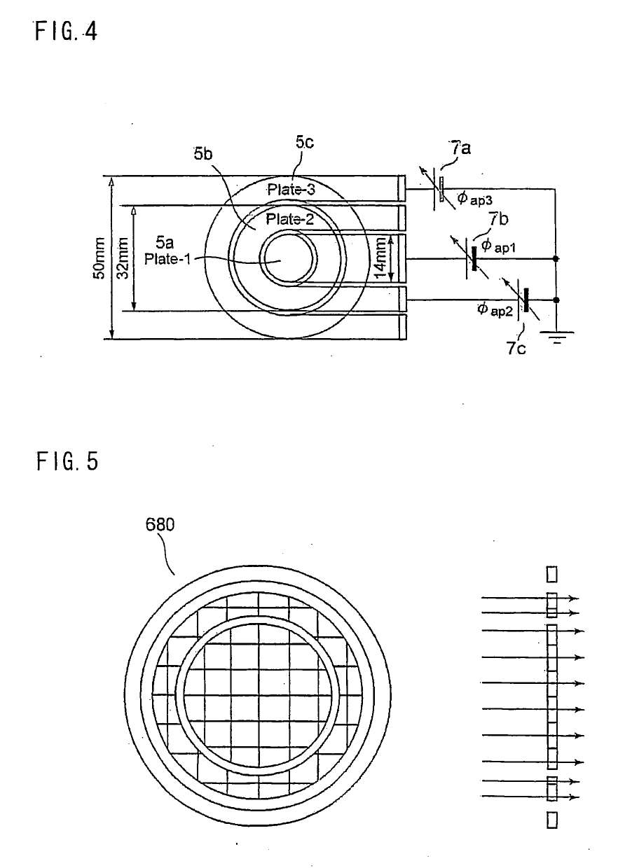

In this embodiment, the potential body 609 is divided into separate concentric plate components as shown in FIG. 4. In the particular embodiment shown in FIG. 4, the potential body is divided into three separate plate components 5a, 5b, 5c. Specifically, the central plate component 5a is circular in form, and around the central plate component 5a, there are annular plate components 5b, 5c, which are electrically insulated from the central plate component 5a. The number of plate components is not limited to three. To the plate components 5a, 5b, 5c, there are attached respective bias voltage applying means 7a, 7b, 7c so that bias voltages can be applied to the plate components independently of each other. The shape of the potential body is not limited to a circle or an annulus, but may be a solid rectangle or an open rectangle or any other shape, as long as that shape is compatible with the shape of the evacuated vessel 610.

The radius of the central plate component 5a is preferably in the range of R+2R_{L} to R+3R_{L} when R represents the radius of the plasma generating chamber, and R_{L} represents the Larmor radius of a doping atom.

Fullerenes entering via the aperture into cylinder 607 but having undergone no ionization migrate with plasma flow and bind to the central plate component 5a of potential body. On the other hand, ionized atoms to be doped migrate tracing a spiral course under the influence of magnetic field and collide with the non-ionized atoms bound to the central plate component 5a to produce endohedral fullerenes. If the Larmor radius of the spiral course traveled by the ions to be doped is R_{L}, the radius of plasma flow will be larger by 2R_{L} than the radius of the plasma generating chamber.

The Larmor radius R_{L} is inversely proportional to the intensity of magnetic field B, and if B=0.3T for example, it is possible, when the temperature of the plasma is 2500° C., to estimate:

R_{L}=0.27 mm for a hydrogen ion, R_{L}=1.0 mm for anitrogen atom, and R_{L}=1.1 mm for a sodium atom.

The Larmor radius R_{L} of a doping atom is proportional to its migration velocity v. If a standard velocity of a doping atom is calculated to be v₀ making allowance for the intensity of magnetic field applied, the likeliness of the migration velocity of the doping atom falling in the range of 0.5 v₀ to 1.5 v₀ is estimated to be 0.5 or more based on the consideration of statistical mechanics. Namely, if the central plate component of 5a of potential body is assumed to have a radius of R+3R_{L}, 50% or more of doping atoms will hit the central plate component 5a. Thus, the potential body is preferably designed such that the radius of the central plate component 5a falls between R+2R_{L} and R+3R_{L}.

The central plate component of potential body 5a is preferably disposed with respect to plasma flow such that its center corresponds with the density peak of fullerenes in plasma flow 660, because then it is possible to increase the yield of doped fullerenes. For this purpose, it is necessary to adjust the bias voltage as appropriate. The optimum bias voltage may vary according to the type of doping atom, type of fullerenes, and deposition condition. However, for a given condition, it is readily possible to determine an optimum bias voltage by resorting to a preliminary experiment.

Assume, for example, that the doping atom is hydrogen or nitrogen, and the fullerene is C₆₀. Then, a bias voltage φap in the range of −5V<φap<+20V is preferably applied to the central plate component 5a. A bias voltage in the range of 0V≦φap≦+18V is particularly preferred.

When a halogen gas is employed as an atom to be doped, a negative voltage of −20V or less is preferably applied to the central plate component 5a of potential body.

When a sodium gas or a potassium gas is employed as an atom to be doped, a positive voltage of +70V or more or +80V or more respectively is preferably applied to the central plate component 5a of potential body.

Incidentally, even if the potential body 609 is not divided into separate plate components but exists as a single body, and a bias voltage is applied to the single body, it is possible to obtain a significant amount of fullerenes by optimizing the deposition condition.

Furthermore, even if the central plate component of potential body 5a receives no bias voltage and stays afloat, it is possible to obtain a significant amount of fullerenes by optimizing the deposition condition.

Like the central plate component of potential body 5a, the peripheral plate components of potential body 5b, 5c may stay afloat or may have a bias voltage applied. Even if the plate component of potential body 5b, 5 stay afloat, the same amount of endohedral fullerenes will deposit on that the potential body 5b as are observed on a conventional plate. With respect to the overall yield of endoheral fullerenes for the entire potential body, however, the yield is still higher as compared with a conventional apparatus, because the yield at the central plate component of potential body 5a remains higher than the corresponding yield of the conventional apparatus.

Of course, it is advisable to apply a bias voltage to the plate component of potential body 5b as appropriate when the density of fullerene ions in contact with the plate component of potential body 5b becomes low as a result of the fluctuation of fullerene deposition, so as to increase the density of the ions in question. Throughout the deposition process of endohedral fullerenes, the density of ions may be monitored with the ion measurement probe, and controlled bias voltages may be automatically supplied to the plate components of potential body 5b, 5c by way of a computer. A controlled bias voltage may be automatically supplied to the central plate component of potential body 5a in the same manner.

To the evacuated vessel 610 is attached an evacuation pump 10 for evacuating gas from the vessel 610 to produce vacuum there. The initial vacuum of the evacuated vessel 610 is preferably 10⁻⁴ Pa or lower.

More preferably the initial vacuum is 10⁻⁶ Pa or lower. If the vacuum is over 10⁻⁶ Pa, an OH⁻ group is bound to the outer wall of an endohedral fullerene. An endohedral fullerene having an OH group attached thereto is chemically stable. Accordingly, it has a good storage stability. On the contrary, if the vacuum is below 10⁻⁶ Pa, endohedral fullerenes having no OH⁻ group attached thereto will be obtained. The endohedral fullerene contains an ionized atom. The reason for this remains unclear.

Incidentally, an inert membrane consisting of a chromic acid oxidation membrane (inert membrane essentially free from a ferric acid oxidation membrane) is preferably applied to the surfaces of evacuated vessel 610 and cylinder 607. Particularly, coating consisting only of a chromic acid oxidation membrane is preferred. This can prevent the adhesion of moisture to the vessel and cylinder considerably, or even when the adhesion of moisture occurs, the stain can be easily wiped out.

The membrane is not limited to the above. Other membrane may be applied to the vessel and cylinder, as long as it rejects the adhesion of moisture or oxygen, or allows, even when moisture or oxygen adheres, the easy removal of adhered moisture or oxygen.

The concentration of impurities (particularly moisture, oxygen, etc.) contained in the gas to be introduced into the apparatus is preferably restricted to 10 ppb or lower, more preferably 1 ppb or lower, most preferably 10 ppt or lower.

Suitable fullerenes to be used according to the invention may include, for example, Cn (n=60, 70, 74, 82, 84, . . . ).

It is possible to further reduce the concentration of neutral fullerenes contained in a membrane deposited on potential body by adjusting the distance Id between the downstream end of the cylinder 607 and the potential body 609 such that Id≧2Ic where Ic represents the length of the cylinder. Namely, it is possible by so doing to further increase the concentration of endohedral fullerenes contained in the membrane.

### Embodiment 2

FIG. 5 shows a second embodiment.

In the first embodiment, the potential body comprises a substrate plate. In this embodiment, the potential body comprises a mesh body 680. The advantages inherent to the divided potential body of the first embodiment are similarly observed in this embodiment.

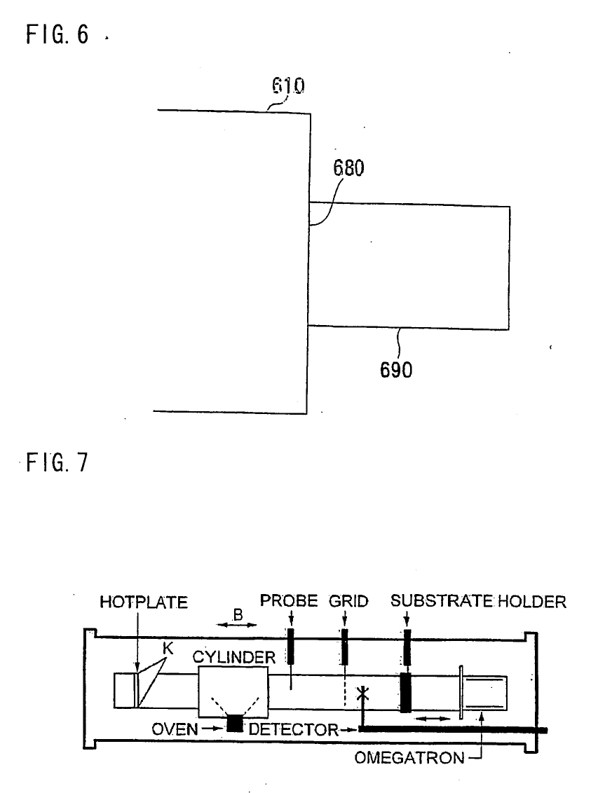

In the first embodiment, endohedral fullerenes deposit on the substrate plate. On the other hand, in this embodiment, endohedral fullerenes pass through the potential body 680 in the form of a mesh. To meet the situation, a collecting container 690 is provided at the downstream side of potential body 680 as shown in FIG. 6 so that endohedral fullerenes can be collected in the collecting container 690.

In the first embodiment, the amount of fullerenes deposited on the substrate plate is restricted to be below a certain limit. Therefore, whenever that limit is reached, the substrate plate must be replaced with a new one. Thus, the continuous operation of the apparatus has a limitation. In contrast, according to this embodiment, the continuous operation is possible until the collecting container 690 is filled. The capacity of storage chamber 690 may be chosen to be sufficiently large as to allow the apparatus to continuously operate until fullerenes contained in the material container 606 shown in FIG. 1 are exhausted. The material container 606 may be constructed so as to enable the continuous feeding of fullerenes.

The collecting container 690 preferably has the same diameter with that of central plate component of potential body 5a of the first embodiment. The collecting container 690 may have a duplicate or triplicate structure. If the collecting container 690 has a triplicate structure for example, the three substructures may have the same diameters with those of plate components of potential body 5a, 5b, 5c.

A chemically modifying group such as OH group may be bound to endohedral fullerenes obtained as above, to confer various features upon them. For example, if a given endohedral fullerene is electrically so unstable that a desired effect is not obtained from it, it may be possible to add a modifier group to the endohedral fullerene to thereby stabilize it electrically. Or it may also possible to bind together plural endohedral fullerenes to produce a polymer of endohedral fullerenes.

### EXAMPLES

### Example 1

Production of hydrogen doped C₆₀ (H C₆₀) fullerenes was performed using an apparatus as shown in FIG. 1.

In this example, the evacuated vessel 610 consists of a stainless steel-made cylinder having an inert membrane made of a chromium oxide coated thereon. Its dimensions were 100 mm in diameter and 1200 mm in length.

The plasma generating chamber 611 consisted of a quartz-made cylinder having a diameter of φ20 mm. Coils were wound around it as shown in FIG. 2, and 13.56 MHz RF currents 180° different in phase were allowed to flow through the coils.

Hydrogen gas whose content of impurities was 10 ppb or less was used. The pressure within the evacuated vessel 610 was maintained at 1×10⁻⁴ Pa, and the intensity B of a magnetic field was kept at B=0.3T.

In the course of a plasma flow 660, there was provided a stainless steel cylinder 607 with an aperture. The cylinder 607 used in this example was a cylinder having an inner diameter of 55 mm. The cylinder 607 was heated to about 400° C.

Then, fullerenes were introduced through the aperture formed on cylinder 607.

On the other hand, the potential body 609 used in this example was of a three segment type. The central plate component of potential body 5a had a diameter of 14 mm. A plate component of potential body 5b external to the central plate component had a diameter of 32 mm. The most external plate component of potential body 5c had a diameter of 50 mm.

To the central plate component of potential body 5a, a bias voltage Δφap (=φap−φs) which was Δφap=5V was applied. The plate components of potential body 5b, 5c stayed afloat from the ground. Here, φap represents a DC voltage while φs the potential of plasma in suspension.

When an ion measurement probe was used to measure the distribution of ions during the formation of a membrane of fullerenes, the data indicated that C₆₀⁻ concentrated onto the central area.

After fullerenes were allowed to deposit for 30 minutes, the profile of fractional endohedral fullerenes (H@C₆₀ in this example) deposited on the potential body was followed. It was found that the membrane component deposited on the central plate component of potential body 5a contained a high fraction of endohedral fullerenes. Furthermore, it was found that the membrane component deposited on the plate component of potential body 5b just peripheral to the central plate component also contained a definite amount of endohedral fullerenes.

The endohedral fullerenes thus obtained were analyzed while being firmly shielded against air. An OH group was found to attach to the external wall of each fullerene. Attachment of an OH group to each endohedral fullerene suggests that the endohedral fullerene is at a state equivalent to a positive monovalent ion. Being equivalent to a positive monovalent ion suggests that the H atom contained in the fullerene exists as H⁺. Since an OH group is attached to the fullerene, the net charge of the endohedral fullerene was null.

### Example 2

In this example, it was studied what effect it has on the yield to vary the diameter of the cylinder 607.

The inner radius D of cylinder 607 was made 30, 40, 48, 50, 60, 70, 80, and 100 mm, fullerenes were allowed to deposit in the same manner as in Example 1, and the yield of endohedral fullerenes was followed.

When the yield of endohedral fullerenes obtained at the central plate component in Example 1 (where Dc=55 mm) is made 1 as a reference, following results were obtained. The parenthesized number indicates the ratio of the inner diameter of the plasma generating chamber to the inner diameter of the cylinder.

30 mm (1.5):0.6

40 mm (2.0):0.7

48 mm (2.4):0.8

50 mm (2.5):0.95

55 mm (2.8):1

60 mm (3.0):0.95

70 mm (3.5):0.7

80 mm (4.0):0.5.

100 mm (5.0):0.5

It is indicated that the yield is far higher when the ratio of the inner diameter of the plasma generating chamber to the inner diameter of the cylinder is allowed to take a value in the range of 2.5 to 3.0 than the case where it takes a value outside the above range.

### Example 3

In this example, a mesh-like potential body was used.

In this example, a good yield was obtained as in Example 2. Continuous operation of the apparatus was possible.

### Example 4

In this example, the vacuum within the evacuated vessel 610 was kept at 10⁻⁶ Pa.

Endohedral fullerenes obtained were analyzed while being firmly shielded against air. No OH group was found to attach to the external wall of fullerenes. No other modifier group attached either. In Example 1, an OH group attached to each endohedral fullerene. This OH group might be derived from water or oxygen in the atmosphere during the production process of endohedral fullerenes.

### Example 5

Empty fullerenes (fullerenes containing no atom in the interior), endohedral fullerenes obtained in Example 1 or endohedral fullerenes obtained in Example 4 were added to samples made of an electroconductive polymer as dopant.

The sheet of the conductive polymer was laid one after another to form a lamination. The lamination was shaped into an electrode which served as an electronic element. Incidentally, the electronic element used in Example 4 was produced in a vacuum kept at 10⁻⁶ Pa.

The characteristic of this electronic element was studied. The characteristic is the ratio of (light current)/(dark current) or light/dark current ratio.

(1) Doped with empty fullerenes

(2) Doped with endohedral fullerenes of Example 1

(3) Dope with endohedral fullerenes of Example 4

The light/dark current ratio was about 1.5 time higher in case (2) than in case (1).

The light/dark current ratio was about 2 times higher in case (3) than in case (1).

Thus, the electronic element obtained in cases (2) and (3) will be effectively used as a solar battery or photo-sensor.

### Example 6

Coils were wounded around the plasma generating chamber by the method shown in FIG. 3. The other respects were the same with those of Example 1.

Endohedral fullerenes were obtained at a higher yield than is observed in Example 1.

### Example 7

In this example, nitrogen gas was used instead of hydrogen gas.

Results approximately the same as those in Example 1 were obtained.

### INDUSTRIAL APPLICABILITY

According to the present invention, it is possible to obtain endohedral fullerens at a high yield. Of those endohedral fullerenes doped with a gas atom, fullerenes doped with a nitrogen ion is particularly prospective because of its characteristic electron structure inherent to nitrogen atom which will see applications in spin-electronics and quantum computer.

1. An apparatus for producing gas atom containing fullerenes comprising a plasma generating chamber with a gas inlet where a gas to be doped is introduced via the gas inlet into said chamber to be converted into a plasma there, and an evacuated vessel which is so constructed as to communicate with the plasma generating chamber to produce a plasma flow and to introduce fullerenes into the plasma flow such that at least part of the fullerenes are ionized, said apparatus being further provided with means for binding ionized atom to be doped to fullerenes thereby causing endohedral fullerens to be formed.

2. The apparatus for producing gas atom containing fullerenes as described in claim 1 wherein the gas comprises atom to be doped which is ionized in plasma to provide electrons and positively charged ions to be doped.

3. The apparatus for producing gas atom containing fullerenes as described in claim 2 wherein means for controlling the energy of electrons in plasma flow is provided in the evacuated vessel towards the plasma generating chamber, and wherein the energy controls the energy of electrons to facilitate the binding of the electrons to fullerenes introduced into the evacuated chamber thereby causing negatively charged fullerene ions to be formed.

4. The apparatus for producing gas atom containing fullerenes as described in claim 3 wherein the energy of the electrons is controlled to be 10 eV or lower.

5. The apparatus for producing gas atom containing fullerenes as described in claim 3 wherein the energy of the electrons is controlled to be 5 eV or lower.

6. The apparatus for producing gas atom containing fullerenes as described in claim 2 wherein the atom to be doped comprises hydrogen atom or nitrogen atom.

7. The apparatus for producing gas atom containing fullerenes as described in claim 1 wherein the gas comprises atom to be doped which is ionized in plasma to provide negatively charged ions to be doped.

8. The apparatus for producing gas atom containing fullerenes as described in claim 7 wherein fullerenes, when introduced into plasma flow, the electrons of fullerenes are expelled, to produce thereby positively charged fullerene ions.

9. The apparatus for producing gas atom containing fullerenes as described in claim 7 wherein the atom to be doped comprises halogen gas atom.

10. The apparatus for producing gas atom containing fullerenes as described in claim 1 wherein the means for binding ionized atom to be doped to fullerenes to cause thereby gas atom-doped fullerenes to be formed is a potential body to which a bias voltage having the same polarity with that of the atom to be doped is applied.

11. The apparatus for producing gas atom containing fullerenes as described in claim 10 wherein the potential body is divided into separate components in a radial direction.

12. The apparatus for producing gas atom containing fullerenes as described in claim 11 constructed such that voltages different from each other can be applied to the separate components.

13. The apparatus for producing gas atom containing fullerenes as described in claim 10 wherein the potential body is a substrate body.

14. The apparatus for producing gas atom containing fullerenes as described in claim 10 wherein the potential body is a mesh body.

15. The apparatus for producing gas atom containing fullerenes as described in claim 14 wherein a collecting container is provided downstream of the mesh body to collect produced endohedral fullerenes.

16. The apparatus for producing gas atom containing fullerenes as described in claim 15 wherein the collecting container is freely attached to or detached from the apparatus.

17. The apparatus for producing gas atom containing fullerenes as described in claim 1 wherein the plasma generating chamber is made of an insulating material, a coil is wound around its external portion, and radiofrequency current is flowed through the coil.

18. The apparatus for producing gas atom containing fullerenes as described in claim 17 wherein RF currents different in phase from each other are flowed through respective plural coils.

19. The apparatus for producing gas atom containing fullerenes as described in claim 17 wherein a wire is wound spirally around one part of the external portion of the plasma generating chamber to form a first coil there, and another wire is wound spirally around another part of the external portion of the plasma generating chamber to form a second coil there, and RF currents different in phase are flowed through the first and second coils.

20. The apparatus for producing gas atom containing fullerenes as described in claim 10 wherein the bias voltage is variable.

21. The apparatus for producing gas atom containing fullerenes as described in claim 11 wherein a bias voltage Δφap in the range of −100V<Δφap<+100V is applied to the central component of the potential body.

22. The apparatus for producing gas atom containing fullerenes as described in claim 11 wherein the radius of the central component is in the range of R+2R_{L} to R+3R_{L} where R represents the radius of the plasma generating chamber, and R_{L} the Larmor radius of a doping atom.

23. The apparatus for producing gas atom containing fullerenes as described in claim 10 wherein means for measuring the distribution of fullerene ions and doping atom ions in plasma flow is provided ahead the potential body, and the bias voltage applied to the potential body is adjusted based on a signal from said means.

24. The apparatus for producing gas atom containing fullerenes as described in claim 1 wherein a cylinder having an inner diameter 2.5 to 3.0 times as large as the diameter of plasma flow is provided midway in the course of the plasma flow.

25. The apparatus for producing gas atom containing fullerenes as described in claim 24 wherein the distance Id between the downstream end of the cylinder and the potential body is adjusted such that Id≧2Ic where Ic represents the length of the cylinder.

26. The apparatus for producing gas atom containing fullerenes as described in claim 24 further comprising a cooling means for cooling at least the wall of the evacuated vessel surrounding the space downstream of the downstream end of the cylinder.

27. The apparatus for producing gas atom containing fullerenes as described in claim 1 wherein an inert membrane made mainly of chromium oxide is applied to the inner surfaces of the plasma generating chamber and evacuated vessel.

28. A method for producing gas atom containing fullerenes using an apparatus as described in claim 1.

29. A method for producing gas atom containing fullerenes comprising the steps of introducing a gas containing atom to be doped into a plasma generating chamber, generating a plasma in the plasma generating chamber, causing the generated plasma to plasma flow, introducing fullerenes into the plasma flow thereby ionizing the fullerenes, and binding ions derived from the atom to be doped to ionized fullerenes thereby causing gas atom containing fullerenes to be formed.

30. The method for producing gas atom containing fullerenes according to claim 29 wherein the gas comprises atom to be doped which is ionized in plasma to provide electrons and positively charged ions to be doped.

31. The method for producing gas atom containing fullerenes according to claim 30 wherein the energy of electrons in plasma is controlled so as to facilitate the binding of electrons to fullerenes thereby causing negatively charged fullerenes to be formed.

32. The method for producing gas atom containing fullerenes according to claim 31 wherein the energy of the electrons is controlled to be 10 eV or lower.

33. The method for producing gas atom containing fullerenes according to claim 31 wherein the energy of the electrons is controlled to be 5 eV or lower.

34. The method for producing gas atom containing fullerenes according to claim 29 wherein the gas comprises atom to be doped which is ionized in plasma to provide negatively charged ions to be doped.

35. The method for producing gas atom containing fullerenes according to claim 34 wherein fullerenes, when introduced into plasma flow, the electrons of fullerenes are expelled, to produce thereby positively charged fullerene ions.

36. The method for producing gas atom containing fullerenes according to claim 29 wherein the plasma generating chamber is made of an insulating material, a coil is wound around its external portion, and RF current is flowed through the coil.

37. The method for producing gas atom containing fullerenes according to claim 36 wherein a pair of coils are wound spirally, and RF currents different in phase are flowed through the pair of coils.

38. The method for producing gas atom containing fullerenes according to claim 36 wherein a wire is wound spirally around one part of the external portion of the plasma generating chamber to form a first coil there, and another wire is wound around spirally another part of the external portion of the plasma generating chamber to form a second coil there, and RF currents different in phase are flowed through the first and second coils.

39. The method for producing gas atom containing fullerenes according to claim 29 wherein the velocity of fullerenes relative to the velocity of ions derived from atom to be doped is reduced at the downstream side of plasma flow in the evacuated vessel.

40. The method for producing gas atom containing fullerenes according to claim 39 wherein a potential body is provided in the evacuated vessel at a site which will correspond with the downstream side of plasma flow, and wherein, during operation, a bias voltage having the same polarity with that of doping ions in plasma is applied, thereby reducing the velocity of doping ions.

41. The method for producing gas atom containing fullerenes according to claim 29 wherein the concentration profile of fullerenes has a peak at the center of plasma flow.

42. The method for producing gas atom containing fullerenes according to claim 40 wherein the potential body is divided into separate components in a radial direction, such that different voltages can be applied to the separate components independently of each other.

43. The method for producing gas atom containing fullerenes according to claim 40 wherein the potential body is a substrate body.

44. The method for producing gas atom containing fullerenes according to claim 40 wherein the potential body is a mesh body.

45. The method for producing gas atom containing fullerenes according to claim 44 wherein a collecting container is provided downstream of the mesh body to collect produced endohedral fullerenes.

46. The method for producing gas atom containing fullerenes according to claim 29 wherein the initial vacuum of the evacuated vessel is 10⁻⁴ Pa or less.

47. A gas atom containing fullerene which is obtained by the method of claim 29.

48. A gas atom containing fullerene containing a hydrogen ion, a nitrogen ion or a halogen gas ion.

49. The gas atom containing fullerene as described in claim 48 that has no modifying group attached thereto.

50. The gas atom containing fullerene as described in claim 48 that has a modifying group attached thereto.

51. An electronic element including an electro-conductive polymer of any one gas atom containing fullerene chosen from those described in claim 47.

52. The electronic element as described in claim 51 which is a solar battery or a photo-sensor.
